(19) United States
(12) Patent Application Publication
(10) Pub. No.: US 2020/0278568 A1
(43) Pub. Date: Sep. 3, 2020

(54) DISPLAY PANEL AND DISPLAY APPARATUS

(71) Applicant: HKC CORPORATION LIMITED, Shenzhen (CN)

(72) Inventor: Chunhui YANG, Chongqing (CN)

(21) Appl. No.: 16/349,605

(22) PCT Filed: Nov. 22, 2018
(86) PCT No.: PCT/CN2018/116861

§ 371 Date: May 13, 2019

(30) Foreign Application Priority Data
Oct. 31, 2018 (CN) 201821778266.9

(51) Int. Cl. G02F 1/1339; G02F 1/1335

(52) U.S. Cl. CPC G02F 1/1339; G02F 1/133512; G02F 2202/28; G02F 2201/123; G02F 1/133514

(57) ABSTRACT

The present application discloses a display panel and a display apparatus. The display panel includes a display area and a peripheral area, and also includes a first substrate, a second substrate disposed opposite to the first substrate, and a frame adhesive formed on the peripheral area to adhere the first substrate and the second substrate in a sealing manner; where, the first substrate is provided with a light shield layer in a position corresponding to the peripheral area, and the light shield layer is provided with a hollow area in a position corresponding to the frame adhesive; the hollow area at least includes a first hollow area and a second hollow area; and a width of the first hollow area is greater than that of the second hollow area.

The present application claims priority to the Chinese Patent Application No. CN201821778266.9, filed with the Chinese Patent Office on Oct. 31, 2018, and entitled “DISPLAY PANEL AND DISPLAY APPARATUS”, which is incorporated herein by reference in its entirety.

### TECHNICAL FIELD

The present application relates to the technical field of display, and in particular, to a display panel and a display apparatus.

### BACKGROUND

The description here only provides background information related to the present application, and does not necessarily constitute the existing technology.

With the development and progress of technology, a flat-panel display becomes a mainstream product of display due to advantages such as thin body, power saving and no radiation, and is widely applied. The flat-panel display includes a thin film transistor-liquid crystal display (TFT-LCD), an organic light-emitting diode (OLED) display and so on. Among the above, the thin film transistor-liquid crystal display generates a screen by controlling a rotation direction of the liquid crystal molecules to refracting the light ray from a backlight module, and has numerous advantages such as thin body, power saving and no radiation.

Taking a liquid crystal display apparatus as an example, TFT-LCD includes four processes: an array process, a color film process, a cell forming process, and a module process. Among the above, the cell forming process includes manufacture procedures such as oriented film engineering, frame adhesive coating, liquid crystal instillation, vacuum cell pasting and cutting. The frame adhesive coating aims to connect the color film substrate and the array substrate to prevent liquid crystal from leaking and to maintain the thickness of the peripheral cell. The ultraviolet curing is required after frame adhesive coating, but the frame adhesive between the heading end and the tailing end of the frame adhesive coating is difficult to cure completely, which affects the sealing adhesion effect of the color film substrate and the array substrate.

### SUMMARY

The present application aims to provide a display panel and a display apparatus to improve the frame adhesive ultraviolet curing effect.

In order to realize the above purpose, the present application provides a display panel that includes a display area and a peripheral area; the display panel includes a first substrate, a second substrate disposed opposite with the first substrate, and a frame adhesive formed on the peripheral area to adhere the first substrate and the second substrate in a sealing manner; the first substrate is provided with a light shield layer in a position corresponding to the peripheral area, and the light shield layer is provided with a hollow area in a position corresponding to the frame adhesive; the hollow area at least includes a first hollow area and a second hollow area; and a width of the first hollow area is greater than that of the second hollow area.

Optionally, the frame adhesive at least includes a first coating area and a second coating area; the first hollow area on the first substrate corresponds to the first coating area; the second hollow area corresponds to the second coating area; and a width of the first coating area is greater than that of the second coating area.

Optionally, orthographic projection of the hollow area on the first substrate completely covers orthographic projection of the frame adhesive on the first substrate, and the orthographic projection area of the hollow area is greater than the orthographic projection area of the frame adhesive.

Optionally, the width of the first hollow area is greater than that of the first coating area, and the width of the second hollow area is greater than that of the second coating area.

Optionally, a distance between a border of the first hollow area and a border of the first coating area is the first distance, a distance between a border of the second hollow area and a border of the second coating area, and the first distance is equal to the second distance within a preset error precision.

Optionally, an edge of the orthographic projection of the first hollow area on the first substance is not in contact with an edge of the orthographic projection of the first coating area on the first substrate; and an edge of the orthographic projection of the second hollow area on the first substrate is not in contact with an edge of the orthographic projection of the second coating area on the first substrate.

Optionally, the first substrate is an array substrate that is provided with a pixel electrode; and the light shield layer is a metal line.

Optionally, the second substrate is provided with a first light shield layer in a position corresponding to the frame adhesive; and the first light shield layer is formed of a black color resistance.

Optionally, two or more first hollow areas are provided.

Optionally, the width of the first hollow area is greater than the sum of the width of the first coating area, a coating error value and a cell pairing error value, a length of the first hollow area is greater than the sum of a length of the first coating area, the coating error value and the cell pairing error value, and the width of the second hollow area is greater than the sum of the width of the second coating area, the coating error value and the cell pairing error value.

The present application also discloses a display panel that includes a display area and a peripheral area, including:

an array substrate; a color film substrate disposed opposite disposing with the array substrate; and a frame adhesive formed on the peripheral area to adhere the first substrate and the second substrate in a sealing manner; the array substrate includes a metal line in a position corresponding to the peripheral area; the metal line includes a first hollow area and a second hollow area; and the first hollow area has a width greater than that of the second hollow area; the color film substrate is provided with a black color resistance in a position corresponding to the first hollow area and the second hollow area; the frame adhesive includes a first coating area and a second coating area; and the first coating area has a width greater than that of the second coating area; the first hollow area of the array substrate corresponds to the first coating area; and the area of the first hollow area on the first substrate completely covers the area of the first coating area on the first substrate; the second hollow area of the array substrate corresponds to the second coating area; and the area of the second hollow area on the first substrate completely covers the area of the second coating area on the first substrate.

The present application also discloses a display apparatus including the display panel according to any one of the above.

In the present application, the first substrate and the second substrate are adhered through the frame adhesive in a sealing manner; the main ingredient of the frame adhesive is a resin added with an epoxy resin that realizes cross linking under ultraviolet radiation; and ultraviolet curing is carried out on the frame adhesive immediately after opposite disposing of the first substrate and the second substrate. If ultraviolet light radiates from the first substrate to carry out ultraviolet curing to the frame adhesive, the first substrate has a metal line that shields the frame adhesive, so that the ultraviolet light does not radiate the frame adhesive, and it is difficult to cure the frame adhesive and affects the adhesion force of the first substrate and the second substrate. In this scheme, the metal line is provided with a hollow area corresponding to the coating area of the frame adhesive. On one hand, the ultraviolet light that radiates from the first substrate side can radiate the frame adhesive through the hollow area of the light shield layer, so as to guarantee the curing effect of the frame adhesive. On the other hand, the frame adhesive is laminated during opposite disposing of the first substrate and the second substrate; and the frame adhesive will fill the hollow area of the metal line, which increases contact area of the frame adhesive and the metal line of the hollow area and strengthens the adhesion force between the frame adhesive and the first substrate.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic diagram of a display panel of one embodiment in the present application;

FIG. 2 is a schematic diagram of another display panel of one embodiment in the present application;

FIG. 3 is a schematic diagram of another display panel of one embodiment in the present application;

FIG. 4 is a schematic diagram of another display panel of one embodiment in the present application;

FIG. 5 is a schematic diagram of another display panel of one embodiment in the present application;

FIG. 6 is a schematic diagram of another display panel of one embodiment in the present application;

FIG. 7 is a schematic diagram of a cross section A-A′ of a display panel of one embodiment in the present application;

FIG. 8 is a schematic diagram of a cross section A-A′ of another display panel of one embodiment in the present application;

FIG. 9 is a schematic diagram of a cross section B-B′ of a display panel of one embodiment in the present application;

FIG. 10 is a schematic diagram of another display panel of one embodiment in the present application;

FIG. 11 is a schematic diagram of a cross section B-B′ of another display panel of one embodiment in the present application;

FIG. 12 is a schematic diagram of another display panel of one embodiment in the present application;

FIG. 13 is a schematic diagram of a cross section B-B′ of another display panel of one embodiment in the present application; and

FIG. 14 is a schematic diagram of a display apparatus of one embodiment in the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms such as “first” and “second” are merely for a descriptive purpose, and cannot be understood as indicating or implying relative importance, or implicitly indicating the number of the indicated technical features. Hence, the features defined by “first” and “second” can explicitly or implicitly include one or more features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or electrically connected; or directly connected or indirectly connected through an intermediate medium, or in an internal communication between two elements. The specific meanings about the foregoing terms in the present application may be understood by those skilled in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

TFT-LCD includes four processes: an array process, a color film process, a cell forming process, and a module process. The cell forming process includes manufacture procedures such as oriented film engineering, frame adhesive coating, liquid crystal instillation, vacuum cell pasting and cutting. The adhesive coating aims to connect the color film substrate and the array substrate to prevent liquid crystal from leaking and to maintain the thickness of the peripheral cell.

Before use, the frame adhesive is subjected to defoaming treatment to prevent small air bubbles in the frame adhesive, avoid that the small air bubbles affect the strength of the frame adhesive and guarantee that no broken line appears in the coating process. The frame adhesive coating guarantees the viscosity of the frame adhesive, stability of the coating amount, stability of the coating position and compatibility of liquid crystal. The main ingredient of the frame adhesive is a resin added with an additive, e.g., a thermally cured single crystal resin and a phenol resin, an epoxy resin that realizes cross linking under ultraviolet radiation. According to the type of the additive, the frame adhesive is divided into a thermally curing type and an ultraviolet curing type. The thermally curing type has a high strength and a long curing time. The ultraviolet curing type has a fast curing speed but a low strength. Currently, it is common in the TFT-LCD industry to add both the thermally curing resin and the ultraviolet curing resin. Ultraviolet curing is carried out immediately after opposite disposing pairing of the array substrate and the color film substrate. The ultraviolet curing mainly includes fast curing the periphery of the frame adhesive, so that it will not cause any error even when in contact with liquid crystal. Thermal curing is carried out after ultraviolet curing to strengthen the adhesion force of the frame adhesive.

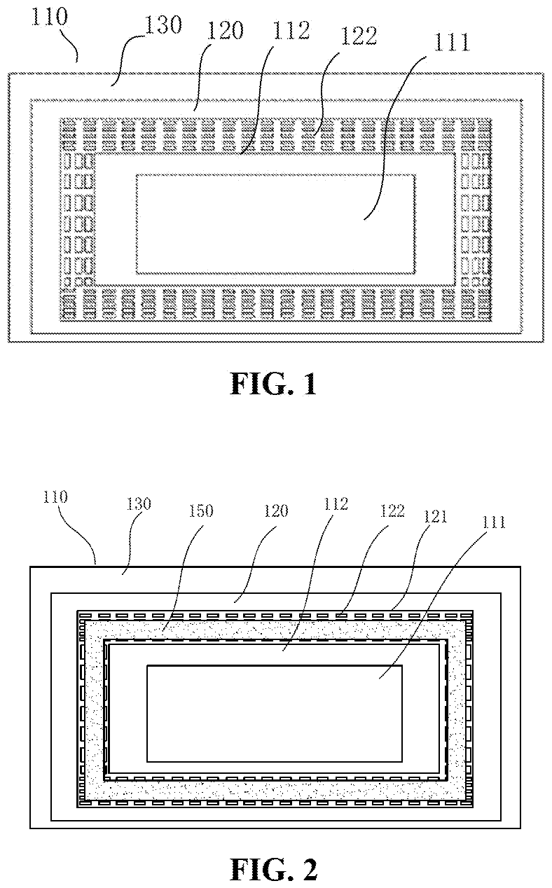

As shown in FIGS. 1 and 2, after the vacuum pasting process, curing of the frame is carried out; if the array substrate (first substrate 120) side is selected to be radiated by the ultraviolet light to carry out ultraviolet curing on the frame adhesive 150. In an area coated with the frame adhesive, the opaque layer on the array substrate side is a hollow design so as to enable the ultraviolet light to pass through conveniently.

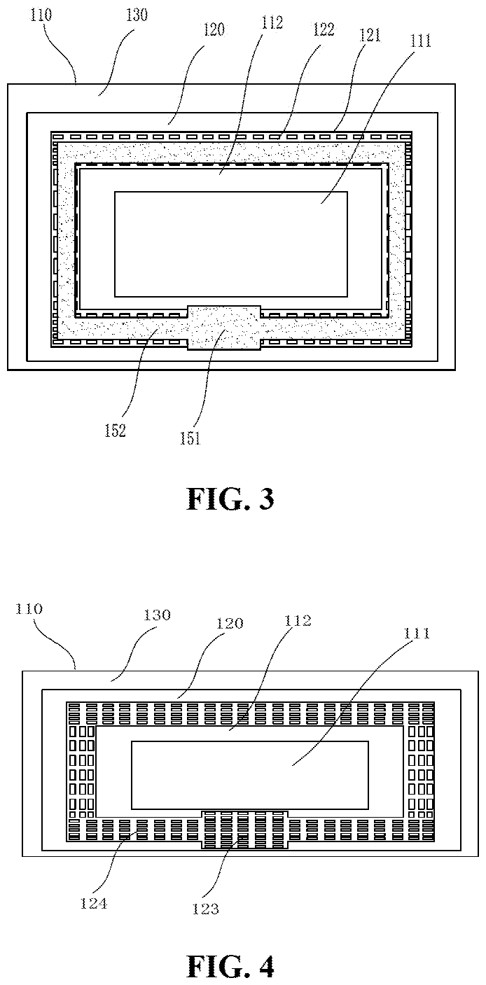

As shown in FIG. 3, while coating with the frame adhesive 150, in order to guarantee end-to-end connection, there are generally an overlapped area (first coating area 151) coated with the frame adhesive at the ends. In the overlapped area, the hollow area 122 of the array substrate does not satisfy the demand of ultraviolet curing of the frame adhesive by the ultraviolet radiation.

The present application is illustrated below in detail in reference with the drawings and optional embodiments.

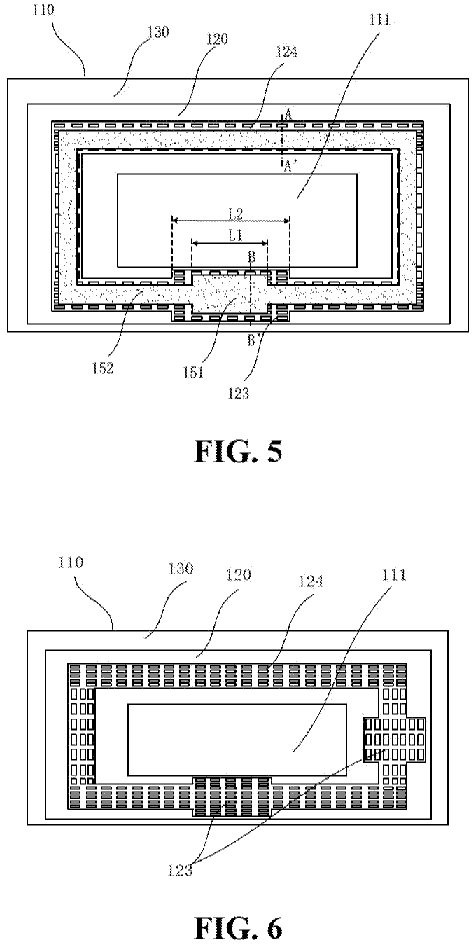

As shown in FIGS. 4 to 6, in one or more embodiments of the present application, it discloses a display panel 110 including a display area 111 and a peripheral area 112; the display panel 110 includes: a first substrate 120; a second substrate 130 disposed in opposite to with the first substrate; and a frame adhesive 150 formed on the peripheral area 112 to adhere the first substrate 120 and the second substrate 130 in a sealing manner; the first substrate 120 includes a light shield layer 121; the light shield layer 121 is provided with a hollow area 122 formed on the peripheral area 112; the hollow area 122 is disposed corresponding to the frame adhesive 150; the hollow area 122 at least includes a first hollow area 123 and a second hollow area 124; and a width of the first hollow area 123 is greater than that of the second hollow area 124. Specifically, the first substrate 120 is an array substrate, and the second substrate 130 is a color film substrate.

The first substrate 120 and the second substrate 130 are adhered through the frame adhesive 150 in a sealing manner; the main ingredient of the frame adhesive 150 is a resin added with an epoxy resin that realizes cross linking under ultraviolet radiation; and ultraviolet curing is carried out on the frame adhesive 150 immediately after opposite disposing of the first substrate 120 and the second substrate 130. If ultraviolet light radiates from the first substrate 120 to carry out ultraviolet curing to the frame adhesive 150, on one hand, the first substrate 120 is provided with a light shield layer 150 that shields the frame adhesive 150, so that the ultraviolet light does not radiate the frame adhesive 150, and it is difficult to cure the frame adhesive 150; on the other hand, in the coating process of the frame adhesive 150, in order to guarantee seal adhering between the first substrate 120 and the second substrate 130, a section of frame adhesive 150 is generally overlapped at the end part coated with the frame adhesive 150, to completely connect the ends of the frame adhesive 150; the overlapped section of frame adhesive 150 is laminated to have a width greater than that of the non-overlapped frame adhesive 152; the widened frame adhesive 150 is shielded by the light shield layer 121, the curing is affected, and the poor curing effect of the frame adhesive 150 will directly affect the adhesion force between the frame adhesive 150 and the first substrate 120 and the second substrate 130, thereby affecting sealing between the first substrate 120 and the second substrate 130.

In this scheme, the light shield layer 121 is provided with a first hollow area 123 and a second hollow area 124 corresponding to the coating area of the frame adhesive 150, and a width of the first hollow area 123 is greater than that of the second hollow area 124; on one hand, the ultraviolet light that radiates from the first substrate 120 side can radiate the frame adhesive 150 or wider frame adhesive 150 through the hollow area 122 of the light shield layer 120, so as to guarantee the curing effect of all the frame adhesive between the first substrate 120 and the second substrate 130; on the other hand, the frame adhesive 150 is laminated during opposite disposing of the first substrate 120 and the second substrate 130; and the frame adhesive 150 will fill the hollow area 122 of the light shield layer 121, which increases contact area of the frame adhesive 150 and the light shield layer 121 of the hollow area 122 and strengthens the adhesion force between the frame adhesive 150 and the first substrate 120.

In one or more embodiments, the coating area of the frame adhesive 150 at least includes a first coating area 151 and a second coating area 152; a width of the first coating area 151 is greater than that of the second coating area 152; and the first hollow area 123 corresponds to the first coating area 151, and the second hollow area 124 corresponds to the second coating area 152.

In this scheme, the first coating area 151 is the coating area where the frame adhesive 150 is overlapped, the second coating area 152 is the coating area where the frame adhesive 150 is not overlapped, and thus the width of the first coating area 151 is greater than that of the second coating area 152. In order to guarantee that the widened first coating area 151 and second coating area 152 can be completely radiated by the ultraviolet light, the hollow area 122 is set correspondingly, so that the first hollow area 123 corresponds to the first coating area 151, the second hollow area 124 corresponds to the second coating area 152, and the width of the first hollow area 123 is greater than that of the second hollow area, thereby guaranteeing the curing effect of all the frame adhesive 150.

In one or more embodiments, orthographic projection of the hollow area 122 on the first substrate 120 completely covers orthographic projection of the frame adhesive 150 on the first substrate 120, and the orthographic projection area of the hollow area 122 is greater than the orthographic projection area of the frame adhesive 150. The orthographic projection of the hollow area 122 on the first substrate 120 completely covers the orthographic projection of the frame adhesive 150 on the first substrate 120, and the orthographic projection area of the hollow area 122 is greater than the orthographic projection area of the frame adhesive 150, so that it guarantees that the frame adhesive 150 is completely located in the hollow area 122; and when the ultraviolet light radiates the hollow area 122 from the first substrate 120, it can guarantee that the frame adhesive 150 is radiated sufficiently by the ultraviolet light, and the frame adhesive 150 has fast curing and a better effect.

In one or more embodiments, the width of the first hollow area 123 is greater than that of the first coating area 151, and the width of the second hollow area 124 is greater than that of the second coating area 152.

In this scheme, the width of the first hollow area 123 is greater than that of the first coating area 151, so that it guarantees that the frame adhesive 150 of the first coating area 151 can be radiated by the ultraviolet light, so as to fast cure the edge of the frame adhesive 150 of the first coating area 151; and the second hollow area 124 is greater than that of the second coating area, so that it guarantees that the adhesive frame 150 of the second coating area 152 can be radiated by the ultraviolet light to fast cure the edge of the frame adhesive 150 of the second coating area 152.

A distance between a border of the first hollow area 123 and a border of the first coating area 151 is the first distance, a distance between a border of the second hollow area 124 and a border of the second coating area 152, and the first distance is equal to the second distance within a preset error precision.

Distances between borders of the first hollow area 123 and the second hollow area 124 and borders of the first coating area 151 and the second coating area 152 are the first distance and the second distance, respectively, so that the structure of the hollow area 122 is regular, and the preset interval shape of the frame adhesive 150 is regular, which is convenient for the light shield layer 121 to use an opening design of the mask while forming the hollow area 124 and is convenient to coat the frame adhesive 150, thereby improving the manufacture efficiency of the display panel 110.

Specifically, as shown in FIG. 6, two or more first hollow areas can be provided to facilitate coating of the frame adhesive 150 in different positions.

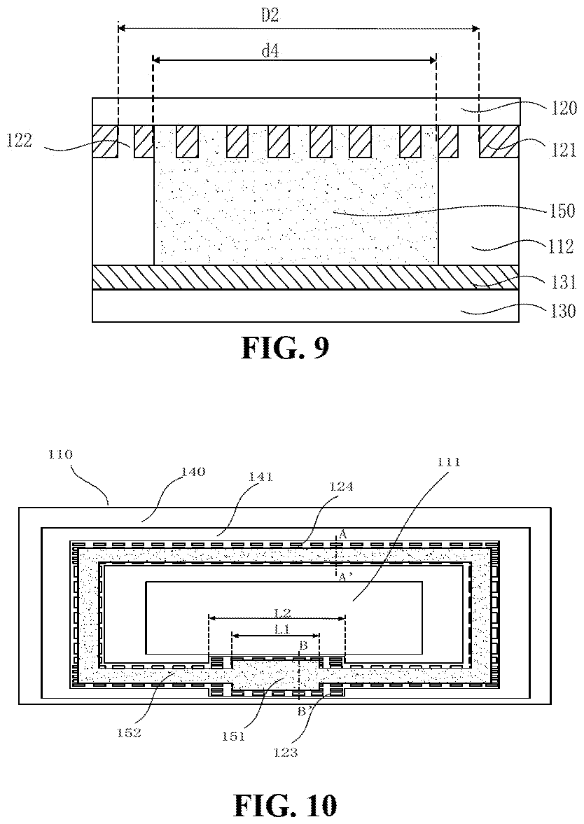

As another embodiment of the present application, referring to FIGS. 8 and 9, the difference from the above embodiments is that, an edge of the orthographic projection of the first hollow area 123 on the first substrate 120 is not in contact with an edge of the orthographic projection of the first coating area 151 on the first substrate 120; and an edge of the orthographic projection of the second hollow area 124 on the first substrate 120 is not in contact with an edge of the orthographic projection of the second coating area 152 on the first substrate 120.

In this scheme, the edge of the orthographic projection of the first coating area 151 is not in contact with the first hollow area 123, and the edge of the orthographic projection of the second coating area 152 is not in contact with the edge of the second hollow area 124, so that it guarantees that the frame adhesive 150 is coated in the middle position of the hollow area 122 instead of the edge position of the hollow area 122, avoids that the edge of the frame adhesive 150 cannot be radiated by the ultraviolet light, and affects curing of the edge of the frame adhesive 150.

As another embodiment of the present application, the difference from the above embodiments is that, the width of the first hollow area 123 is greater than the sum of the width of the first coating area 151, a coating error value and a cell pairing error value, a length of the first hollow area 123 is greater than the sum of a length of the first coating area 151, the coating error value and the cell pairing error value, and the width of the second hollow area 124 is greater than the sum of the width of the second coating area 152, the coating error value and the cell pairing error value.

In this scheme, there is a certain error value while coating the frame adhesive 150, so that the coated frame adhesive 150 deviates from the predetermined frame adhesive 150 area; there is a certain error value during opposite disposing of the first substrate 120 and the second substrate 130, so that offset occurs to correspondence between the hollow area 122 and the frame adhesive 150 area; and a part of the frame adhesive 150 cannot be radiated by the ultraviolet light during ultraviolet curing of the frame adhesive 150, which affects the ultraviolet curing effect of the frame adhesive 150. In this scheme, taking the above factors into full consideration, while designing the width of the hollow area 122, the width of the hollow area 122 is greater than the sum of the width of the first coating area 151, a coating error value and a cell pairing error value, a length of the first hollow area 123 is greater than the sum of a length of the first coating area 151, the coating error value and the cell pairing error value, and the width of the second hollow area 124 is greater than the sum of the width of the second coating area 152, the coating error value and the cell pairing error value, so that the frame adhesive 150 can be completely located in the hollow area 122 in a case in which the coating error value and the cell pairing error value present, and the frame adhesive 150 can be completely radiated by the ultraviolet light from the hollow area 122 during ultraviolet curing, thereby guaranteeing the ultraviolet curing effect of the frame adhesive 150.

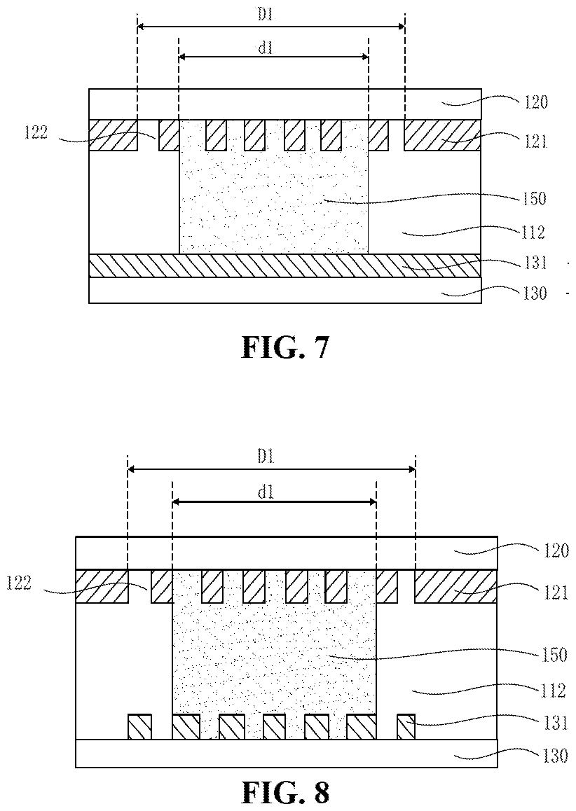

As another embodiment of the present application, referring to FIGS. 7 to 9, the first substrate 120 is an array substrate provided with a pixel electrode, and the light shield layer 121 is a hollow metal line; the second substrate 130 is provided with a first light shield layer 131 in a position corresponding to the frame adhesive 150, and the first light shield layer 131 is formed of a black color resistance.

In this scheme, after the metal line of the first substrate 120 is provided with a hollow area 122 in the position of the frame adhesive 150, if the corresponding second substrate 130 is provided with a first light shield layer 131, the hollow area 122 leaks light and the display effect is affected; the hollow metal line on the first substrate 120 can allow the ultraviolet light that cures the frame adhesive 150 to pass through, so as to cure the frame adhesive 50; the black color resistance on the second substrate 130 can shield the hollow area 122 on the first substrate 120, and shield the area on the second substrate 130 that may leak light, without additionally disposing a first light shield layer 131 in the position of the hollow area 122, thereby removing the manufacture procedure of the first light shield layer 131 corresponding to the hollow area 122.

Of course, the first substrate 120 may also be a color film substrate, the light shield layer 121 is a hollow black color resistance; correspondingly, the second substrate 130 is an array substrate, and the first light shield layer 131 is a metal line.

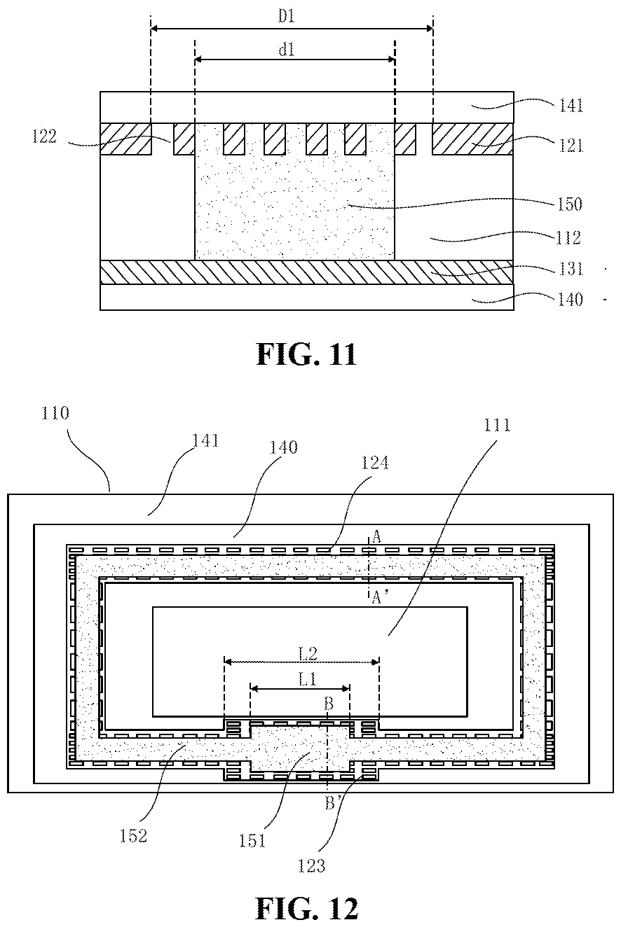

As another embodiment of the present application, referring to FIGS. 10 and 11, the difference from the above embodiments is that, it discloses a display panel 110 formed with a display area 111 and a peripheral area 112; the display panel 110 includes: an array substrate 141; a color film substrate 140 disposed opposite with the array substrate 141; and a frame adhesive 150 formed on the peripheral area 112 to adhere the first substrate 120 and the second substrate 130 in a sealing manner;

The array substrate 141 is provided with a metal line in a position corresponding to the peripheral area 111; the metal line includes a first hollow area 123 and a second hollow area 124; the first hollow area 123 and the second hollow area 124 are connected to form a rectangular closed-loop structure; the width of the first hollow area 123 is greater than that of the second hollow area 124; and the color film substrate 140 is provided with a black color resistance in a position corresponding to the first hollow area 123 and the second hollow area 124;

The frame adhesive 150 includes a first coating area 151 and a second coating area 152; the first coating area 151 and the second coating area 152 are connected to form a rectangular closed-loop structure; and the width of the first coating area 151 is greater than that of the second coating area 152;

The first hollow area 123 of the array substrate 141 corresponds to the first coating area 151; the orthographic projection of the first hollow area 123 on the first substrate 120 completely covers the orthographic projection of the first coating area 151 on the first substrate 120; and the edge of the orthographic projection of the first hollow area 123 on the first substrate 120 is not in contact with the edge of the orthographic projection of the first coating area 151 on the first substrate 120;

The second hollow area 124 of the array substrate 141 corresponds to the second coating area 152; the orthographic projection of the second hollow area 124 on the first substrate 120 completely covers the orthographic projection of the second coating area 152 on the first substrate 120; and the edge of the orthographic projection of the second hollow area 124 on the first substrate 120 is not in contact with the edge of the orthographic projection of the second coating area 152 on the first substrate 120.

In this scheme, the metal line is provided with a first hollow area 123 and a second hollow area 124 corresponding to the frame adhesive 150, so that the ultraviolet light that radiates from the array substrate 141 side can radiate the frame adhesive 150 through the first hollow area 123 and the second hollow area 124 of the metal line so as to carry out ultraviolet curing on the frame adhesive 150.

In the coating process of the frame adhesive 150, in order to guarantee seal adhering of the color film substrate 140 and the array substrate 141, a section of frame adhesive 150 is generally overlapped at the ends coated with the frame adhesive 150 so as to completely connect the ends of the frame adhesive 150; the overlapped section of frame adhesive 150 is laminated to have a width greater than that of the non-overlapped coating area; the first coating area 151 is the overlapped coating area of the frame adhesive 150, the second coating area 152 is the non-overlapped coating area of the frame adhesive 150, and the first coating area 151 needs a corresponding wider hollow area 122 to guarantee that the frame adhesive 150 of the first coating area 151 can completely receive ultraviolet curing. The first hollow area 123 corresponds to the first coating area 151, the second hollow area 124 corresponds to the second coating area 152; and the area of the first hollow area 123 is greater than that of the first coating area 151, the area of the second hollow area 124 is greater than that of the second coating area 152; and the first coating area 151 is completely located in the first hollow area 123, the second coating area 152 is completely located in the second hollow area 124, so that the ultraviolet light that radiates from the first hollow area 123 and the second hollow area 124 can completely radiate a surface of the frame adhesive 150 when the ultraviolet light radiates the coating area of the frame adhesive 150 from the first substrate 120, thereby guaranteeing the ultraviolet curing effect of the frame adhesive 150. In addition, the metal line of the hollow area 122 corresponding to the frame adhesive 150 will be in direct contact with the frame adhesive 150 while coating the frame adhesive 150, and the fame adhesive 150 will cover the opening of the hollow area 122 to increase the contact area of the frame adhesive 150 and the metal line and increase the adhesion force of the frame adhesive 150 and the first substrate 120.

Specifically, the first hollow area 123 and the second hollow area 124 are connected to form a rectangular closed-loop structure, the first coating area 151 and the second coating area 152 are connected to form a rectangular closed-loop structure, and two adjacent sides of the closed-loop structure are perpendicular to each other.

The hollow area 122 and the frame adhesive 150 are rectangular closed-loop structures, and the closed-loop structures are regular, which is convenient to make an opening on the corresponding mask in the manufacture process of the hollow area 122 and is convenient to perform the coating operation of the frame adhesive 150.

The width value of the first coating area 151 is d1, the coating error value is d2, and the cell pairing error value is d3; the width value of the second coating area 152 is d4, the length value of the second hollow area 124 is L1, the width value of the first hollow area 123 is D1, the width value of the second hollow area 124 is D2, and the length value of the second hollow area 124 is L2, then:

D1≥d1+d2+d3; d4>d1; D2≥d4+d2+d3; L2≥L1+d2+d3

where, d1 has a range of 100-5000 um; d2 is less than plus/minus 500 um (depending specifically on each coating width and the performance of the coating machine); d3 is less than plus/minus 50 um (depending specifically on the capability of the cell pairing process); and d4 has a range of 100-10000 um.

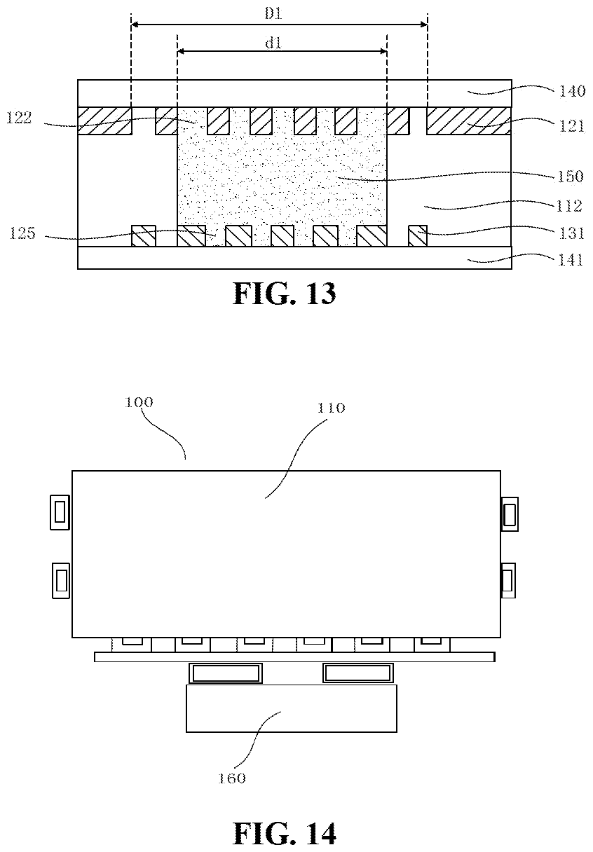

As another embodiment of the present application, referring to FIGS. 12 and 13, it discloses a display panel 110 formed with a display area 111 and a peripheral area 112, including a color film substrate 140; an array substrate 141 disposed opposite with the color film substrate 140; and a frame adhesive 150 formed on the peripheral area 112 to adhere the color film substrate 140 and the array substrate 141 in a sealing manner;

The color film substrate 140 is provided with a black color resistance in the peripheral area 112; the black color resistance includes a first hollow area 123 and a second hollow area 124; the first hollow area 123 and the second hollow area 124 are connected to form a rectangular closed-loop structure; and the width of the first hollow area 123 is greater than the second hollow area 124;

The array substrate 141 is provided with a light shield metal line in a position corresponding to the hollow area 122; and the metal line is corresponding and complementary to the first hollow area 123 and the second hollow area 124 in a perpendicular direction;

The peripheral area 112 includes a first coating area 151 and a second coating area 152 coated with the frame adhesive 150; the first coating area 151 and the second coating area 152 are connected to form a rectangular closed-loop structure, and the width of the first coating area 151 is greater than that of the second coating area 152;

The first hollow area 123 of the color film substrate 140 corresponds to the first coating area 151; the orthographic projection of the first hollow area 123 on the first substrate 120 completely covers the orthographic projection of the first coating area 151 on the first substrate; and the edge of the orthographic projection of the first hollow area 123 on the first substrate 120 is not in contact with the edge of the orthographic projection of the first coating area 151 on the first substrate 120;

The second hollow area 124 of the color film substrate 140 corresponds to the second coating area 152; the orthographic projection of the second hollow area 124 on the first substrate 120 completely covers the orthographic projection of the second coating area 152 on the first substrate 120; the edge of the orthographic projection of the second hollow area 124 on the first substrate 120 is not in contact with the edge of the orthographic projection of the second coating area 152 on the first substrate 120; and all the areas of the frame adhesive 150 are shielded by the first hollow area 123 and the second hollow area 124 of the color film substrate 140 and/or the metal line of the array substrate 141.

In this scheme, the coating process of the frame adhesive 150, in order to guarantee seal adhering of the color film substrate 140 and the array substrate 141, a section of frame adhesive 150 is generally overlapped at the ends coated with the frame adhesive 150 so as to completely connect the ends of the frame adhesive 150; the overlapped section of frame adhesive 150 is laminated to have a width greater than that of the non-overlapped coating area; the first coating area 151 is the overlapped coating area of the frame adhesive 150, the second coating area 152 is the non-overlapped coating area of the frame adhesive 150, and the first coating area 151 needs a corresponding wider hollow area 122 to guarantee that the frame adhesive 150 of the first coating area 151 can completely receive ultraviolet curing.

The first hollow area 123 corresponds to the first coating area 151, the second hollow area 124 corresponds to the second coating area 152, and the area of the first hollow area 123 is greater than that of the first coating area 151, the area of the second hollow area 124 is greater than that of the second coating area 152; and the first coating area 151 is completely located in the first hollow area 123, the second coating area 152 is completely located in the second hollow area 124, so that the ultraviolet light that radiates from the first hollow area 123 and the second hollow area 124 can completely radiate a surface of the flame adhesive 150 when the ultraviolet light radiates the coating area of the frame adhesive 150 from the color film substrate 140, thereby guaranteeing the curing effect of the frame adhesive 150.

As another embodiment of the present application, referring to FIG. 14, it discloses a display apparatus 100 including a display panel 110 of any one of the above and a drive circuit 160 coupled with the display panel 110; and the drive circuit 160 drives the display panel 110 to work normally.

The technical scheme of the present application can be widely applied to a TN panel (called Twisted Nematic, i.e., twisted nematic panel), an IPS panel (In-PlaneSwitching), and an MVA panel (Multi-domain Vertical Alignment, multi-domain alignment technology), and of course, can also be applied to other types of panels.

The above contents are detailed optional descriptions for the present application in conjunction with the specific optional implementation, and it cannot be affirmed that the specific implementation of the present application is only limited to these descriptions. For those skilled in the art of the present application, several simple deductions or replacements can further be made without departing from the idea of the present application and should be deemed as belonging to the scope of protection of the present application.

What is claimed is:

1. A display panel comprising a display area and a peripheral area, the display panel comprising:
a first substrate;
a second substrate disposed opposite with the first substrate; and
a frame adhesive formed on the peripheral area to adhere the first substrate and the second substrate in a sealing manner;
wherein, the first substrate is provided with a light shield layer in a position corresponding to the peripheral area; the light shield layer is provided with a hollow area in a position corresponding to the frame adhesive; the hollow area at least comprises a first hollow area and a second hollow area; and a width of the first hollow area is greater than that of the second hollow area.

2. The display panel according to claim 1, wherein, the frame adhesive at least comprises a first coating area and a second coating area; the first hollow area on the first substrate corresponds to the first coating area; the second hollow area corresponds to the second coating area; and a width of the first coating area is greater than that of the second coating area.

3. The display panel according to claim 1, wherein, orthographic projection of the hollow area on the first substrate completely covers orthographic projection of the frame adhesive on the first substrate, and the orthographic projection area of the hollow area is greater than the orthographic projection area of the frame adhesive.

4. The display panel according to claim 3, wherein, the width of the first hollow area is greater than that of the first coating area, and the width of the second hollow area is greater than that of the second coating area.

5. The display panel according to claim 4, wherein, a distance between a border of the first hollow area and a border of the first coating area is the first distance, a distance between a border of the second hollow area and a border of the second coating area, and the first distance is equal to the second distance within a preset error precision.

6. The display panel according to claim 4, wherein, an edge of the orthographic projection of the first hollow area on the first substance is not in contact with an edge of the orthographic projection of the first coating area on the first substrate; and an edge of the orthographic projection of the second hollow area on the first substrate is not in contact with an edge of the orthographic projection of the second coating area on the first substrate.

7. The display panel according to claim 1, wherein, the first substrate is an array substrate that is provided with a pixel electrode; and the light shield layer is a metal line.

8. The display panel according to claim 7, wherein, the second substrate is provided with a first light shield layer in a position corresponding to the frame adhesive; and the first light shield layer is formed of a black color resistance.

9. The display panel according to claim 1, wherein, two or more first hollow areas are provided.

10. The display panel according to claim 5, wherein, the width of the first hollow area is greater than the sum of the width of the first coating area, a coating error value and a cell pairing error value, a length of the first hollow area is greater than the sum of a length of the first coating area, the coating error value and the cell pairing error value, and the width of the second hollow area is greater than the sum of the width of the second coating area, the coating error value and the cell pairing error value.

11. A display panel, comprising a display area and a peripheral area, comprising:
an array substrate;
a color film substrate disposed opposite with the array substrate; and
a frame adhesive formed on the peripheral area to adhere the first substrate and the second substrate in a sealing manner;
wherein the array substrate comprises a metal line in a position corresponding to the peripheral area; the metal line comprises a first hollow area and a second hollow area; and the first hollow area has a width greater than that of the second hollow area;
the color film substrate is provided with a black color resistance in a position corresponding to the first hollow area and the second hollow area;
the frame adhesive comprises a first coating area and a second coating area; and the first coating area has a width greater than that of the second coating area;
the first hollow area of the array substrate corresponds to the first coating area; and the area of the first hollow area on the first substrate completely covers the area of the first coating area on the first substrate;
the second hollow area of the array substrate corresponds to the second coating area; and the area of the second hollow area on the first substrate completely covers the area of the second coating area on the first substrate.

12. A display apparatus, comprising a display panel that comprises:
a first substrate;
a second substrate disposed opposite with the first substrate; and
a frame adhesive formed on the peripheral area to adhere the first substrate and the second substrate in a sealing manner;
wherein, the first substrate is provided with a light shield layer in a position corresponding to the peripheral area; the light shield layer is provided with a hollow area in a position corresponding to the frame adhesive; the hollow area at least comprises a first hollow area and a second hollow area; and a width of the first hollow area is greater than that of the second hollow area.

13. The display apparatus according to claim 12, wherein, the frame adhesive at least comprises a first coating area and a second coating area; the first hollow area on the first substrate corresponds to the first coating area; the second hollow area corresponds to the second coating area; and a width of the first coating area is greater than that of the second coating area.

14. The display apparatus according to claim 12, wherein, orthographic projection of the hollow area on the first substrate completely covers orthographic projection of the frame adhesive on the first substrate, and the orthographic projection area of the hollow area is greater than the orthographic projection area of the frame adhesive.

15. The display apparatus according to claim 13, wherein, the first hollow area and the second hollow area are connected to form a rectangular closed-loop structure; the first coating area and the second coating area are connected to form a rectangular closed-loop structure; and two adjacent sides of the closed-loop structure are perpendicular to each other.

16. The display apparatus according to claim 12, wherein, the frame adhesive at least comprises a first coating area and a second coating area; the first hollow area corresponds to the first coating area; the second hollow area corresponds to the second coating area; the area of the first hollow area is greater than that of the first coating area, the area of the second hollow area is greater than that of the second coating area; and the first coating area is completely located in the first hollow area, and the second coating area is completely located in the second hollow area.

17. The display apparatus according to claim 12, wherein, the first substrate is an array substrate that is provided with a pixel electrode; the light shield layer is a metal line; the second substrate is a color film substrate; the second substrate is provided with a first light shield layer in a position corresponding to the frame adhesive; and the first light shield layer is formed of a black color resistance.
